(19) United States
(12) Patent Application Publication
(10) Pub. No.: US 2015/0187316 A1
(43) Pub. Date: Jul. 2, 2015

(54) POSITIVE AND NEGATIVE VOLTAGE GENERATING CIRCUIT, LIQUID CRYSTAL DISPLAY MODULE DRIVING SYSTEM, AND VOICE OVER INTERNET PROTOCOL PHONE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: CHIA-CHENG SUN, New Taipei (TW); HONG-GUANG CHENG, Shenzhen (CN); JEN-TUAN CHEN, New Taipei (TW)

(73) Assignees: HONG FU JIN PRECISION INDUSTRY (ShenZhen) CO., LTD., Shenzhen (TW); HON HAI PRECISION INDUSTRY CO., LTD., New Taipei (TW)

(21) Appl. No.: 14/262,823

(22) Filed: Apr. 28, 2014

(30) Foreign Application Priority Data
Dec. 31, 2013 (CN) 2013107508180

(51) Int. Cl. G09G 3/36; H02M 3/07; H02M 7/06

(52) U.S. Cl. CPC G09G 3/3696; H02M 7/06; H02M 3/07; G09G 2330/021

(57) ABSTRACT

A positive and negative voltage generating circuit includes a first rectification circuit, a first voltage stabilizing circuit, a boost circuit, a second rectification circuit, and a second voltage stabilizing circuit. The first rectification circuit rectifies input voltage signals. The first voltage stabilizing circuit stabilizes the rectified input voltage signals to output a negative voltage needed by an LCD module. The boost circuit up-converts the input voltage signals to output a first voltage. The second rectification circuit rectifies the first voltage. The second voltage stabilizing circuit stabilizes the rectified first voltage to output a positive voltage needed by the LCD module. An LCD module driving system and a VOIP phone are also provided.

### BACKGROUND

1. Technical Field

The disclosure relates to positive and negative voltage generating circuits, and particularly to a positive and negative voltage generating circuit used in an liquid crystal display (LCD) module driving system and a voice over internet protocol (VOIP) phone.

2. Description of Related Art

In a VOIP phone, a LCD module of the VOIP phone needs a positive voltage and a negative voltage to drive in a display mode, and current values of the positive voltage and the negative voltage are both less than 1 mA. The positive voltage and the negative voltage can be generated by a DC-DC (direct current) converting circuit. However, a converting efficiency of the DC-DC converting circuit is poor because the current of the positive voltage and the negative voltage are too small. Therefore, there is a need for a positive and negative voltage generating circuit that can overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the views.

FIG. 1 is a schematic diagram of a first embodiment of an LCD driving system.

FIG. 2 is a schematic diagram of a first embodiment of a positive and negative voltage generating circuit.

FIG. 3 is a schematic diagram of a second embodiment of a positive and negative voltage generating circuit.

FIG. 4 is a circuit diagram of a third embodiment of a positive and negative voltage generating circuit.

FIG. 5 is a circuit diagram of a second embodiment of an LCD driving system.

FIG. 6 is a schematic diagram of a first embodiment of a VOIP phone.

FIG. 7 is a circuit diagram of a second embodiment of a VOIP phone.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

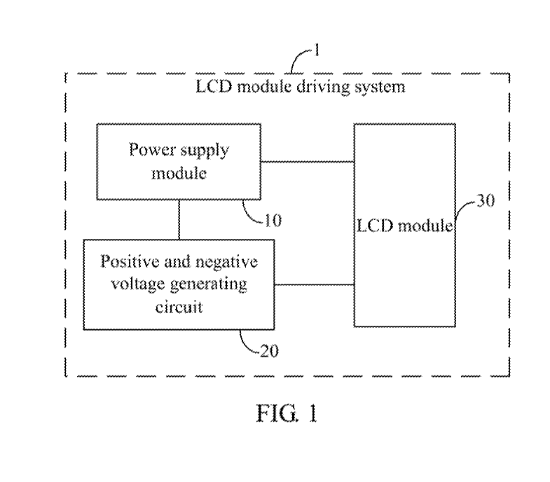

FIG. 1 is a schematic diagram of a first embodiment of an LCD driving system 1. In one embodiment, the LCD driving system 1 comprises a power supply module 10, a positive and negative voltage generating circuit 20, and an LCD module 30. The positive and negative voltage generating circuit 20 is connected to the power supply module 10 and the LCD module 30, and the LCD module 30 is further connected to the power supply module 10. The LCD module 30 receives power signals from the power supply module 10 and the positive and negative voltage generating circuit 20. The positive and negative voltage generating circuit 20 obtains spike pulse voltage signals from the power supply module 10, and converts the spike pulse voltage signals into a positive voltage VGH and a negative voltage VGL.

In one embodiment, the power supply module 10 outputs a 10 V voltage signal, a 5 V voltage signal, and a 3.3 V voltage signal. A value of the positive voltage VGH is 18 V, a value of the negative voltage VGL is −7 V, and current values of the positive voltage VGH and the negative voltage VGL are both 0.205 mA. The positive and negative voltage generating circuit 20 obtains the spike pulse voltage signals from the power supply module 10 instead of a common voltage signal output by the power supply module 10 because the current values of the positive voltage VGH and the negative voltage VGL are too small, and a converting efficiency of the positive and negative voltage generating circuit 20 converting the common voltage signal is poor. The common voltage signal can be the 10 V voltage signal, the 5 V voltage signal, and the 3.3 V voltage signal. The positive and negative voltage generating circuit 20 obtains and converts the spike pulse voltage signals so that the unnecessary spike pulse voltage signals of the power supply module 10 is suppressed, and the voltage signals output by the power supply module 10 are stabilized.

In one embodiment, the 3.3 V voltage signal can be used to drive chips of the LCD module 30, and the 10 V voltage signal can be used to drive backlights of the LCD module 30.

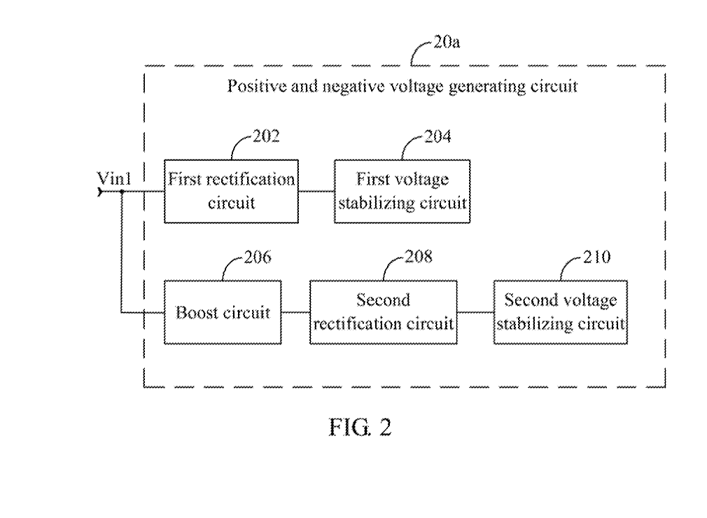

FIG. 2 is a schematic diagram of a first embodiment of a positive and negative voltage generating circuit 20a. In one embodiment, the positive and negative voltage generating circuit 20a comprises a first rectification circuit 202, a first voltage stabilizing circuit 204, a boost circuit 206, a second rectification circuit 208, and a second voltage stabilizing circuit 210. The first rectification circuit 202 rectifies input voltage signals Vin1. The first voltage stabilizing circuit 204 is connected to the first rectification circuit 202, and stabilizes the rectified input voltage signals Vin1 to output the negative voltage VGL needed by the LCD module 30. The boost circuit 206 up-converts the input voltage signals Vin1 to output a first voltage. The second rectification circuit 208 is connected to the boost circuit 206, and rectifies the first voltage. The second voltage stabilizing circuit 210 is connected to the second rectification circuit 208, and stabilizes the rectified first voltage to output the positive voltage VGH needed by the LCD module 30.

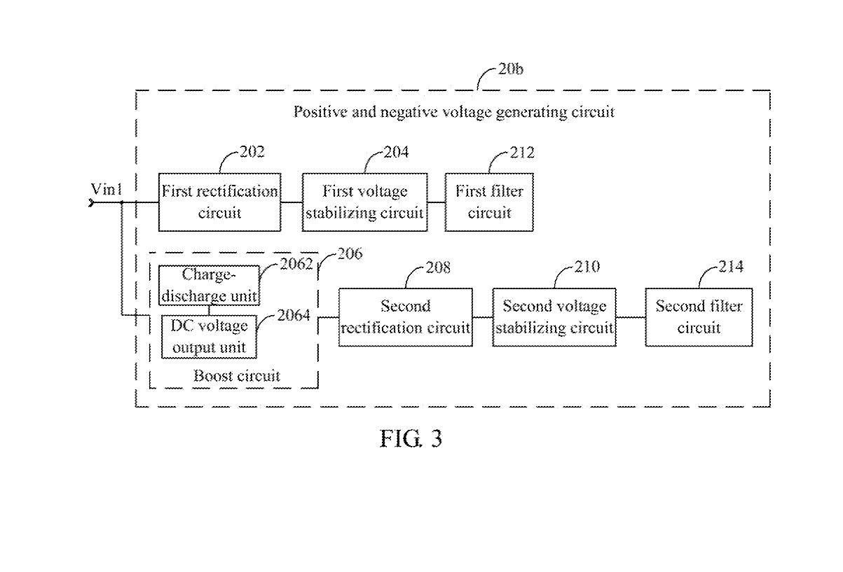

FIG. 3 is a schematic diagram of a second embodiment of a positive and negative voltage generating circuit 20b. In one embodiment, the positive and negative voltage generating circuit 20b is similar to the positive and negative voltage generating circuit 20a of the first embodiment, and the difference between the positive and negative voltage generating circuit 20a and the positive and negative voltage generating circuit 20b is that the positive and negative voltage generating circuit 20b further comprises a first filter circuit 212 and a second filter circuit 214, and the boost circuit 206 comprises a charge-discharge unit 2062 and a DC voltage output unit 2064. The first filter circuit 212 is connected to the first voltage stabilizing circuit 204, and filters the negative voltage VGL output by the first voltage stabilizing circuit 204. The second filter circuit 214 is connected to the second voltage stabilizing circuit 210, and filters the positive voltage VGH output by the second voltage stabilizing circuit 210.

The direct current (DC) voltage output unit 2064 outputs a second voltage. The charge-discharge unit 2062 is charging and discharging continuously, and the charge-discharge unit 2062 charges and discharges according to the input voltage signals Vin1 so as to add the input voltage signals Vin1 to the second voltage to output the first voltage. When the charge-discharge unit 2062 is in a charged mode, the input voltage signals Vin1 charge the charge-discharge unit 2062. When the charge-discharge unit 2062 is in a discharged mode, the charge-discharge unit 2062 adds a discharge voltage and the second voltage together to boost the input voltage signals Vin1 to output the first voltage. The charge-discharge unit 2062 further isolates the DC voltage output unit 2064 from the first rectification circuit 202 so that the first rectification circuit 202 can rectify the input voltage signals Vin1.

In one embodiment, the second voltage can be a 5 V DC voltage signal, and the input voltage signals Vin1 can be the spike pulse voltage signals generated by the power supply module 10 in a voltage converting mode. When the power supply module 10 is in a voltage converting mode, the voltage signals are output.

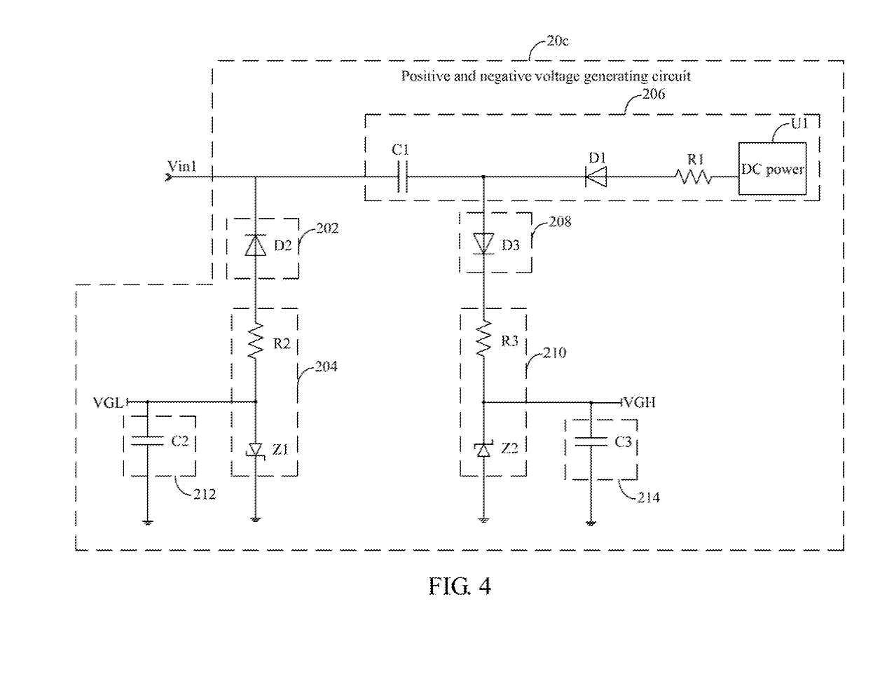

FIG. 4 is a circuit diagram of a third embodiment of a positive and negative voltage generating circuit 20c. In one embodiment, the charge-discharge unit 2062 comprises a first capacitor, and the DC voltage output unit 2064 comprises a DC power U1, a first diode D1, and a first resistor R1. A cathode of the first diode D1 is connected to a first end of the first capacitor C1, an anode of the first diode D1 is connected to a first end of the first resistor R1, and a second end of the first resistor R1 is connected to the DC power U1.

The first rectification circuit 202 comprises a second diode D2, and a cathode of the second diode D2 is connected to a second end of the first capacitor C1. The first voltage stabilizing circuit 204 comprises a second resistor R2 and a first zener diode Z1. A first end of the second resistor R2 is connected to an anode of the second diode D2, a second end of the second resistor R2 is connected to an anode of the zener diode Z1, and a cathode of the zener diode Z1 is grounded. The first filter circuit 212 comprises a second capacitor C2. A first end of the second capacitor C2 is connected to a node between the second resistor R2 and the first zener diode Z1, and a second end of the second capacitor C2 is grounded. The positive and negative voltage generating circuit 20c converts the input voltage signals Vin1 into the negative voltage VGL needed by the LCD module 30 via the second diode D2 rectifying, the first zener diode Z1 stabilizing, and the second capacitor C2 filtering.

The second rectification circuit 208 comprises a third diode D3, an anode of the third diode D3 is connected to a node between the first diode D1 and the first capacitor C1. The second voltage stabilizing circuit comprises a third resistor R3 and a second zener diode Z2. A first end of the third resistor R3 is connected to a cathode of the third diode D3, a second end of the third resistor R3 is connected to a cathode of the second zener diode Z2, and an anode of the second zener diode Z2 is grounded. The second filter circuit 214 comprises a third capacitor C3, a first end of the third capacitor C3 is connected to a node between the third resistor R3 and the second zener diode Z2, and a second end of the third capacitor C3 is grounded. The first capacitor C1 adds the input voltage signals Vin1 and the second voltage to boost the input voltage signals Vin1. The positive and negative voltage generating circuit 20c converts the boosted input voltage signals Vin1 into the positive voltage VGH needed by the LCD module 30 via the third diode D3 rectifying, the second zener diode Z2 stabilizing, and the third capacitor C3 filtering.

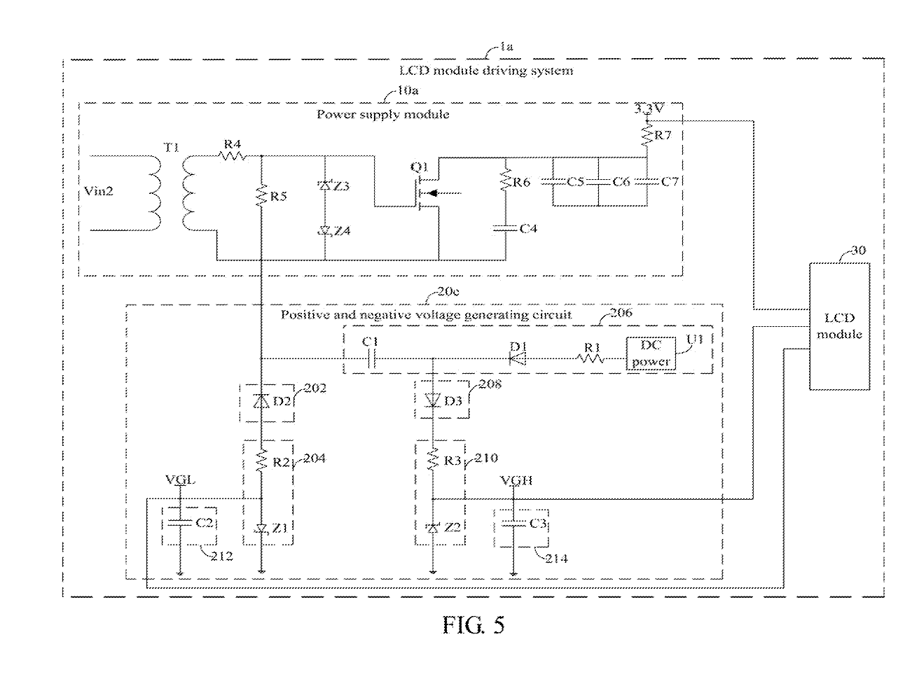

FIG. 5 is a circuit diagram of a second embodiment of an LCD driving system 1a. In one embodiment, the LCD driving system 1a comprises a power supply module 10a, the positive and negative voltage generating circuit 20c, and the LCD module 30. The power supply module 10a converts external power signals Vin2 to drive backlights and chips of the LCD module 30. The power supply module 10a comprises a transformer T1, a fourth resistor R4, a fifth resistor R5, a sixth resistor R6, a seventh resistor R7, a fourth capacitor C4, a fifth capacitor C5, a sixth capacitor C6, a seventh capacitor C7, a third zener diode Z3, a fourth zener diode Z4, and a metal-oxide semiconductor field effect transistor (MOSFET) Q1.

The power supply module 10a can be known power modules that convert the external power signals Vin2, i.e., power modules that already exist in current technology.

In one embodiment, the power supply module 10a converts the external power signals Vin2 into the 3.3 V voltage signal. The transformer T1 outputs square wave voltage signals, and the square wave voltage signals are converted into the 3.3 V voltage signal. The square wave voltage signals comprises the unnecessary spike pulse voltage signals because of parameter errors in elements of the power supply module 10a or external environment effects in actual circuit design, and a value of the spike pulse voltage signals is greater than a value of the square wave voltage signals. The positive and negative voltage generating circuit 20c obtains the spike pulse voltage signals from a output terminal of the transformer T1, and converts the spike pulse voltage signals into the positive voltage VGH and the negative voltage VGL to drive the LCD module 30.

In one embodiment, the DC power U1 can be omitted, and the second voltage is supplied by the power supply module 10a.

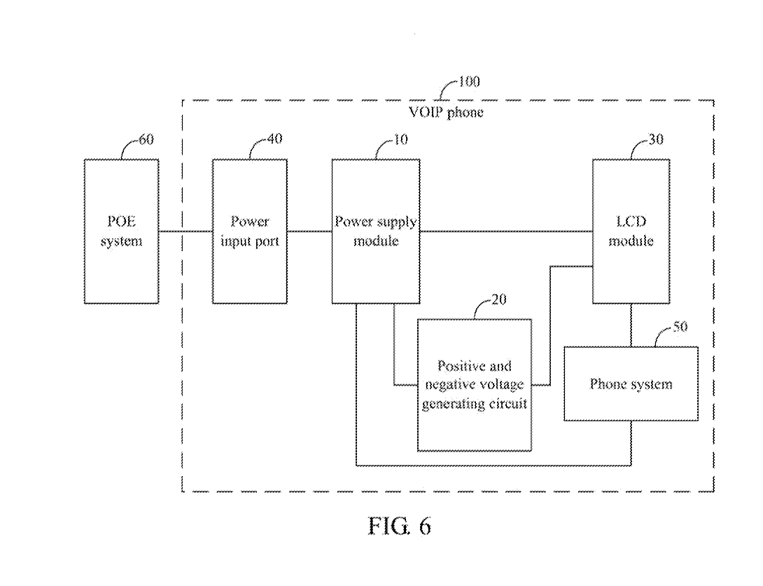

FIG. 6 is a schematic diagram of a first embodiment of a VOIP phone 100. In one embodiment, the VOIP phone 100 comprises the power supply module 10, the positive and negative voltage generating circuit 20, the LCD module 30, a power input port 40, and a phone system 50. The power input port 40 receives and sends the external power signals to the power supply module 10, and the power supply module 10 converts the external power signals to drive the LCD module 30 and the phone system. The power input port 40 and the phone system 50 can be modules that already exist in current technology.

In one embodiment, the external power signals are output by a power over Ethernet (POE) system 60. The external power signals also can be output by other electric signal output modules in other embodiments.

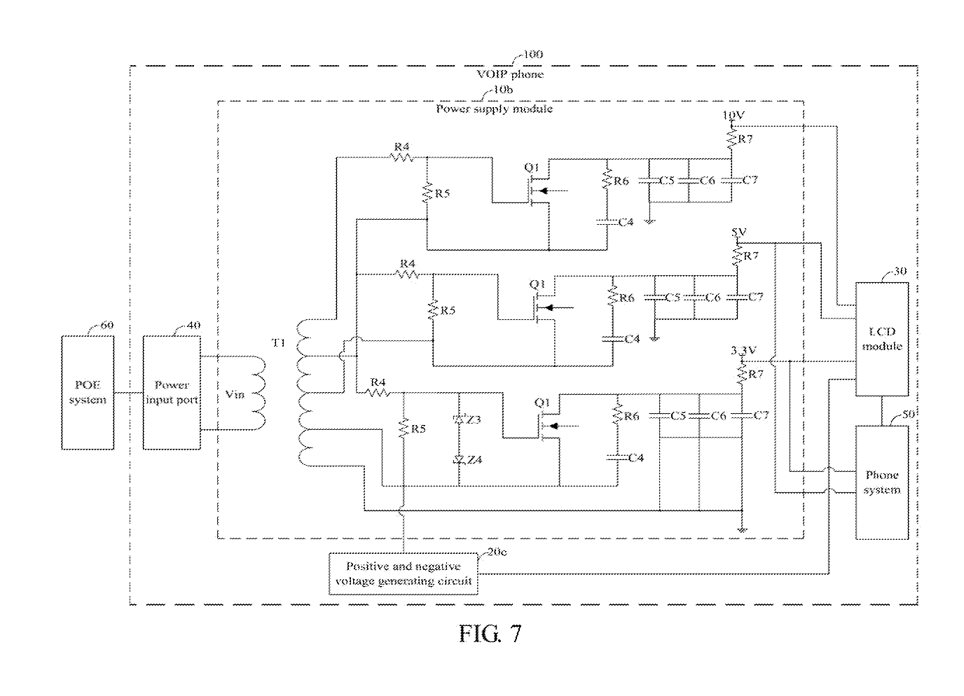

FIG. 7 is a circuit diagram of a second embodiment of a VOIP phone 100a. In one embodiment, the VOIP phone 100 comprises a power supply module 10b, the positive and negative voltage generating circuit 20c, the LCD module 30, the power input port 40, and the phone system 50. The power supply module 10b output three types of voltage signals, such as the 10 V voltage signal, the 5 V voltage signal, and the 3.3 V voltage signal to drive the LCD module 30 and the phone system 50. The LCD module 30 further needs the positive voltage VGH and the negative voltage VGL to display.

In one embodiment , the LCD module 30 receives the 10 V voltage signal, the 5 V voltage signal, and the 3.3 V voltage signal, and the phone system 50 receives the 5 V voltage signal and the 3.3 V voltage signal. The positive voltage VGH and the negative voltage VGL also can be generated by known DC converting modules that generate the positive voltage VGH and the negative voltage VGL, i.e., DC converting modules that already exist in current technology.

The foregoing disclosure of various embodiments has been presented for the purposes of illustration. It is not intended to be exhaustive or limited to the precise forms disclosed. Many variations and modifications of the embodiments described herein will be apparent to one of ordinary skill in the art in the light of the above disclosure. The scope is to be defined only by the claims appended hereto and their equivalents.

What is claimed is:

1. A positive and negative voltage generating circuit comprising:
a first rectification circuit rectifying input voltage signals;
a first voltage stabilizing circuit connected to the first rectification circuit, the first voltage stabilizing circuit stabilizing the rectified input voltage signals to output a negative voltage needed by an liquid crystal display (LCD) module;
a boost circuit up-converting the input voltage signals to output a first voltage;
a second rectification circuit connected to the boost circuit, the second rectification circuit rectifying the first voltage; and
a second voltage stabilizing circuit connected to the second rectification circuit, the second voltage stabilizing circuit stabilizing the rectified first voltage to output a positive voltage needed by the LCD module.

2. The positive and negative voltage generating circuit of claim 1, further comprising:
a first filter circuit connected to the first voltage stabilizing circuit, the first filter circuit filtering the negative voltage output by the first voltage stabilizing circuit; and
a second filter circuit connected to the second voltage stabilizing circuit, the second filter circuit filtering the positive voltage output by the second voltage stabilizing circuit.

3. The positive and negative voltage generating circuit of claim 1, wherein the boost circuit comprises:
a direct current (DC) voltage output unit that outputs a second voltage; and
a charge-discharge unit that charges and discharges according to the input voltage signals to add the input voltage signals to the second voltage to output the first voltage.

4. The positive and negative voltage generating circuit of claim 3, wherein the charge-discharge unit comprises a capacitor, and the DC voltage output unit comprises:
a DC power;
a resistor with a first end connected to the DC power; and
a diode with an anode connected to a second end of the resistor, and a cathode connected to the charge-discharge unit and the second rectification circuit.

5. The positive and negative voltage generating circuit of claim 4, wherein the charge-discharge unit further isolates the DC voltage output unit from the first rectification circuit so that the first rectification circuit can rectify the input voltage signals.

6. The positive and negative voltage generating circuit of claim 1, wherein the first voltage stabilizing circuit comprises:
a first resistor with a first end connected to the first rectification circuit; and
a first zener diode with an anode connected to a second end of the first resistor, and a cathode grounded;
wherein the second voltage stabilizing circuit comprises:
a second resistor with a first end connected to the second rectification circuit; and
a second zener diode with a cathode connected to a second end of the second resistor, and an anode grounded.

7. The positive and negative voltage generating circuit of claim 1, wherein the input voltage signals comprise spike pulse voltage signals.

8. The positive and negative voltage generating circuit of claim 1, wherein a voltage value of the spike pulse voltage signals is greater than 7 V and less than 18 V, and a current value of the spike pulse voltage signals is less than 1 mA.

9. An LCD module driving system comprises an LCD module, a power supply module, and a positive and negative voltage generating circuit comprising:
a first rectification circuit rectifying input voltage signals;
a first voltage stabilizing circuit connected to the first rectification circuit, the first voltage stabilizing circuit stabilizing the rectified input voltage signals to output a negative voltage needed by the LCD module;
a boost circuit up-converting the input voltage signals to output a first voltage;
a second rectification circuit connected to the boost circuit, the second rectification circuit rectifying the first voltage; and
a second voltage stabilizing circuit connected to the second rectification circuit, the second voltage stabilizing circuit stabilizing the rectified first voltage to output a positive voltage needed by the LCD module.

10. The LCD module driving system of claim 9, wherein the positive and negative voltage generating circuit is connected to the LCD module and the power supply module, the positive and negative voltage generating circuit obtains spike pulse voltage signals from the power supply module that generates in a voltage converting mode.

11. A voice over internet protocol (VOIP) phone comprising:
a phone system;
an LCD module;
a power supply module;
a power input port receiving power signals from a power over Ethernet (POE) system and sending the power signals to the power supply module, the power supply module converting the received power signals to drive the LCD module and the phone system; and
a positive and negative voltage generating circuit comprising:
a first rectification circuit rectifying input voltage signals;
a first voltage stabilizing circuit connected to the first rectification circuit, the first voltage stabilizing circuit stabilizing the rectified input voltage signals to output a negative voltage needed by the LCD module;
a boost circuit up-converting the input voltage signals to output a first voltage;
a second rectification circuit connected to the boost circuit, the second rectification circuit rectifying the first voltage; and
a second voltage stabilizing circuit connected to the second rectification circuit, the second voltage stabilizing circuit stabilizing the rectified first voltage to output a positive voltage needed by the LCD module.

12. The VOIP phone of claim 11, wherein the positive and negative voltage generating circuit is connected to the LCD module and the power supply module, and the positive and negative voltage generating circuit obtains spike pulse voltage signals from the power supply module that generates in a voltage converting mode.
